(19) United States
(12) Patent Application Publication
(10) Pub. No.: US 2007/0112110 A1
(43) Pub. Date: May 17, 2007

(54) Composition for producing polyester and polyamide yarns with improved moisture management properties

(76) Inventors: Brendan F. McSheehy JR., Abingdon, VA (US); Milton K. Roark, Bristol, VA (US); Matthew B. Studholme, Abingdon, VA (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/516,046

(22) Filed: Sep. 6, 2006

Related U.S. Application Data
(60) Provisional application No. 60/713,758, filed on Sep. 6, 2005.

(51) Int. Cl. B32B 7/12

(52) U.S. Cl. 524/186

(57) ABSTRACT

Fibers for use in making textiles and floor coverings are made from a moisture management composition that includes polyesters or polyamides and polyoxyalkyleneamines.

The present application is related to and claims the priority of Provisional Application Ser. No. 60/713,758, filed Sep. 6, 2005.

### BACKGROUND AND FIELD OF THE INVENTION

This invention relates generally to a composition and process for preparing articles having improved moisture management properties. More particularly, the invention relates to a composition and process for preparing polyester-based fibers and polyamide-based fibers that exhibit improved moisture management or wicking properties without detrimental loss of other desirable physical properties. The fibers of the invention may be used in both textile and floor covering applications.

Synthetic fibers have generally suffered from an inability to wick moisture efficiently. Improvements in the wicking properties of fibers are highly desirable in many applications. For example, in a textile application such as an article of apparel, including an efficient wicking fiber may provide the wearer with greater perceived comfort. In a floor covering application, improved wicking properties may assist in drying of the floor covering after shampooing and cleaning. In addition, improved wicking assists in the transport of accidental water-based unsightly stains away from the face of the floor covering to the backing, thus hiding the stain from view. We have invented a new composition which is very effective and economical in providing moisture wicking polyester fibers and polyamide fibers used in making textiles and floor coverings.

### SUMMARY OF THE INVENTION

According to our invention, a composition for preparing polyester-based yarns or polyamide-based yarns having improved moisture management properties includes a polyester or polyamide, and one or more polyoxyalkyleneamines. Preferably, the composition contains from about 97 to about 99.75% by weight of polyester or polyamide and from about 0.25% to about 3% by weight of polyoxyalkyleneamine. Most preferably, the composition contains from about 98 to about 99.5% by weight of polyester or polyamide and from about 0.5% to 2% by weight of polyoxyalkyleneamine.

The polyoxyalkyleneamine may be added directly to the polyester or polyamide, or in the form of a thermoplastic concentrate or masterbatch by compounding it in a suitable thermoplastic carrier. Suitable thermoplastic carriers are polyester or polyamide or mixtures thereof. The polyamide includes those synthesized from lactams, alpha-omega amino acids, and pairs of diacids and diamines. Such polyamides include, but are not limited to, polycaprolactam [polyamide 6], polyundecanolactam [polyamide 11], polyhexamethylene adipamide [polyamide 66], polylauryllactam [polyamide 12], poly(hexamethylene dodecanediamide [polyamide 6,12], poly(hexamethylene sebacamide) [polyamide 6,10], poly(ethylene terephthalate), poly(butylene terephthalate), poly(trimethylene terephthalate). If the polyoxyalklenediamine is used in this masterbatch form, then the amount of polyester or polyamide in the above formulation is adjusted to take into account the amount of the thermoplastic carrier in the polyoxyalkylenediamine masterbatch.

The preferred polyoxyalkyleneamine is poly(oxyethylene)diamine (POED) with a molecular weight of about 2000. Another preferred polyoxyalkyleneamine that can be used in the invention is poly(oxypropylene)diamine, also with a molecular weight of 2000. These compounds are available from Huntsman Corporation under the jeffamine® trademark. Further details of suitable polyoxyalkylenediamines are described in U.S. Pat. No. 3,654,370.

Polyesters include thermoplastic polyesters such as those synthesized from one or more diacids and one or more glycols. Such polyesters include, but are not limited to, poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), or mixtures thereof.

Polyamides include thermoplastic polyamides such as those synthesized from lactams, alpha-omega amino acids, and pairs of diacids and diamines. Such polyamides include, but are not limited to, polycaprolactam [polyamide 6], polyundecanolactam [polyamide 11], polyhexamethylene adipamide [polyamide 66], polylauryllactam [polyamide 12], poly(hexamethylene dodecanediamide [polyamide 6,12], and poly(hexamethylene sebacamide) [polyamide 6,10].

Besides the polyester or polyamide, and polyoxyalkyleneamines described above, the compositions used in the practice of the invention may contain other components. These include, but are not limited to, colorants, antioxidants, UV stabilizers, antiozonants, soilproofing agents, stainproofing agents, antistatic additives, flame retardants, antimicrobial agents, lubricants, melt viscosity and melt strength enhancers, chain extenders, coupling agents, solid-state polymerization accelerators and processing aids.

Fibers produced from the composition can be melt-spun using various methods to create different products for a multitude of end use applications. The fibers can be spun using standard spinning machinery known to those skilled in the art including both slow speed and high speed spinning processes. A range of denier per filament (dpf) may be produced depending on the ultimate end use to which such fibers may be put, for example low dpf for textile use and higher dpf for use in carpets. The cross-sectional shape of the fibers may also be any of a wide range of possible shapes, including round, delta, trilobal, tetralobal, grooved or irregular.

These product fibers may be subjected to any of the known downstream processes normally carried out on melt-spun fibers, including crimping, bulking, twisting, etc., to produce yarns suitable for incorporation into a variety of articles of manufacture, such as apparel, threads, textiles, upholstery fabrics, carpets and other floorcoverings. The fibers may be blended, entangled, twisted or other mixed with other fiber types including, but not limited to, synthetic fibers such as polyesters, polyolefins or acrylics, or natural fibers such as wool or cotton, and mixtures thereof.

### BRIEF DESCRIPTION OF THE DRAWINGS

FIG. 1 is a graph of wicking test results of knit socks produced from the yarns of Examples 1-3, and

FIG. 2 is a graph of wicking test results of knit socks produced from the yarns of Examples 4-6.

### EXAMPLES OF THE INVENTION

These examples are provided to illustrate the invention but are not intended to limit the scope of the invention in any way.

### Example 1

15% by weight of POED was compounded with PET, IV=0.67, in a vented twin-screw extruder, stranded, pelletized and dried. The POED masterbatch was further compounded in a vented twin-screw extruder at the 10% level with PET, IV=0.67 and a black color concentrate. The resulting compound was dried and spun on a melt-extruder fiber spinning line at 3100 m/minute and false-twist textured to give a 150 denier yarn consisting 34 filaments of a round cross-section (150/34R).

### Example 2

A comparative (non-inventive) 150/34R yarn was spun and false-twist textured in a similar manner to Example 1, except the POED masterbatch was omitted.

### Example 3

15% by weight of POED was compounded with nylon 6, RV=3.3, in a vented twin-screw extruder, stranded, pelletized and dried. The POED masterbatch was further compounded in a vented twin-screw extruder at the 10% level with PET, IV=0.67 dlg⁻¹, and a black color concentrate. The resulting compound was dried and spun on a melt-extruder fiber spinning line at 3100 m/minute and false-twist textured to give a 150 denier yarn consisting 34 filaments of a round cross-section (150/34R).

The yarns produced in Examples 1-3 were circular knitted into socks of about 3-4 oz/yd². The water transport rate was determined as follows: The water transport rate is measured according to a so-called vertical strip wicking test. One end of a sock (approx. 4 inches wide×12 inches long) was clamped vertically with the dangling end immersed to about ¼ inch in distilled water at 21° C. The time taken for the water to be transported along the strip every inch (distance traveled) was measured. Shorter times per distance traveled indicate greater liquid water transport ability.

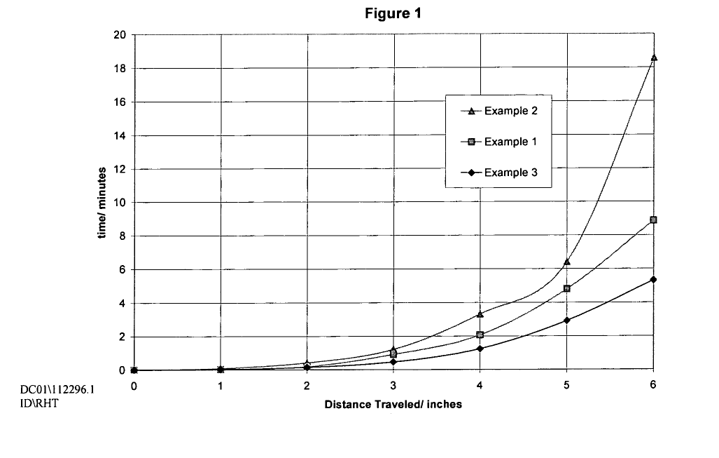

Table 1 shows the test results for Examples 1 to 3 for the vertical strip wicking test. These results are shown graphically in FIG. 1. The results for both the inventive Examples 1 and 3 show a dramatic improvement in water transport rate over the non-inventive Example 2.

TABLE 1

| | Time of travel | Time of travel | Time of travel |
|---|---|---|---|
| Distance | for Example 1/ | for Example 2/ | for Example 3/ |
| traveled/inches | minutes | minutes | minutes |
| 0 | 0:00 | 0:00 | 0:00 |
| 1 | 0:02 | 0:05 | 0:02 |
| 2 | 0:11 | 0:25 | 0:09 |
| 3 | 0:55 | 1:13 | 0:28 |
| 4 | 2:04 | 3:19 | 1:15 |
| 5 | 4:48 | 6:25 | 2:55 |
| 6 | 8:52 | 18:34 | 5:19 |

### Example 4

15% by weight of POED was compounded with PET, IV=0.67 dlg⁻¹, in a vented twin-screw extruder, stranded, pelletized and dried. The POED masterbach was further compounded in a vented twin-screw extruder with Irgarod RA20, a chain extender available from Ciba Specialty Chemicals, Inc., in the ratio of 10 parts of the POED masterbatch to 2 parts of Irgamod RA20. The resulting material was then melt compounded with a nylon 6,6 resin, RV=3.1. This compound was dried and spun on a melt-extruder fiber spinning line to give a 1850/30Y undrawn yarn. Two undrawn yarns bundles were draw-textured and entangled together to give a 1200/06Y BCF yarn.

### Example 5

A comparative (non-inventive) nylon 6,6 1200/60Y BCF yarn was produced without the addition of the POED masterbatch or the Irgamod RA20.

### Example 6

15% weight of POED was compounded with nylon 6, RV=3.3, in a vented twin-screw extruder. The POED masterbatch produced was letdown into nylon 6,6, RV=3.1 directly on a fiber-spinning extruder, arn ends were draw-textured and entangled to give a 1200/60Y BCF yarn.

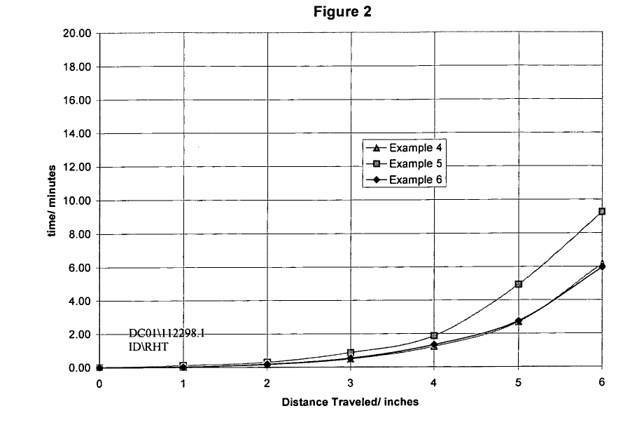

The yarn produced in Examples 4-6 were knitted into socks of similar construction on on a circular knitter. The water transport rate was determined for each sock in a similar manner to that described above. The results are given in Table 2 and shown graphically in FIG. 2. Inventive examples 4 and 6 showed significantly higher water wicking rate over the non-inventive example 5.

TABLE 2

| | Time of travel | Time of travel | Time of travel |
|---|---|---|---|
| Distance | for Example 4/ | for Example 5/ | for Example 6/ |
| traveled/inches | minutes | minutes | minutes |
| 0 | 0:00 | 0:00 | 0:00 |
| 1 | 0:02 | 0:07 | 0:02 |
| 2 | 0:10 | 0:18 | 0:11 |
| 3 | 0:29 | 0:52 | 0:32 |
| 4 | 1:14 | 1:52 | 1:20 |
| 5 | 2:41 | 5:56 | 2:45 |
| 6 | 6:10 | 9:15 | 5:57 |

We claim:

1. A moisture management composition comprising:
(a) a thermoplastic polyester or a thermoplastic polyamide, and
(b) a polyoxyalkyleneamine.

2. A composition as defined in claim 1, wherein said thermoplastic polyester is a fiber-forming thermoplastic polyester.

3. A composition as defined in claim 1, wherein said thermoplastic polyamide is a fiber-forming thermoplastic polyamide.

4. A composition as defined in claim 1, wherein said thermoplastic polyester comprises a polyester selected from the group consisting of poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), and mixtures thereof.

5. A composition as defined in claim 1, wherein said thermoplastic polyamide comprises a polyamide selected from the group consisting of polycaprolactam [polyamide 6], polyundecanolactam [polyamide 11], polyhexamethylene adipamide [polyamide 66], polylauryllactam [polyamide 12], poly(hexamethylene dodecanediamide [polyamide 6,12], and poly(hexamethylene sebacamide) [polyamide 6,10].

6. A composition as defined in claim 1, wherein said polyoxyalkyleneamine comprises a compound selected from the group consisting of poly(oxyethylene)diamine and poly(oxypropylene)diamine, and mixtures thereof.

7. A composition as defined in claim 1, containing from about 97 to 99.75% by weight polyester or polyamide and from about 0.25 to 3% by weight polyoxyalkyleneamine.

8. A composition as defined in claim 7, containing from about 98 to 99.5% by weight polyester or polyamide and from about 0.5 to 2% by weight polyoxyalkyleneamine.

9. A fiber made from the moisture management composition of claim 1.

10. A moisture management composition comprising:
(a) a thermoplastic polyester or a thermoplastic polyamide, and
(b) a concentrate including both a polyoxyalkylenediamine and a thermoplastic polyamide or a thermoplastic polyester carrier resin.

11. A composition as defined in claim 10, wherein said thermoplastic polyester comprises a polyester selected from the group consisting of poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), and mixtures thereof.

12. A composition as defined in claim 10, wherein said thermoplastic polyamide comprises a polyamide selected from the group consisting of polycaprolactam [polyamide 6], polyundecanolactam [polyamide 11], polyhexamethylene adipamide [polyamide 66], polylauryllactam [polyamide 12], poly(hexamethylene dodecanediamide [polyamide 6,12], and poly(hexamethylene sebacamide) [polyamide 6,10].

13. A composition as defined in claim 10, wherein said polyoxyalkyleneamine comprises a compound selected from the group consisting of poly(oxyethylene)diamine and poly(oxypropylene)diamine, and mixtures thereof.

14. A composition as defined in claim 10, wherein said thermoplastic polyamide or thermoplastic polyester carrier resin comprises a polyamide selected from the group consisting of polyamide 6, polyamide 11, polyamide 66, polyamide 12, polyamide 6,12, polyamide 6,10, poly(ethylene terephthalate), poly(butylene terephthalate), poly(trimethylene terephthalate), and mixtures thereof.

15. A fiber made from the moisture management composition of claim 10.
